(19) United States
(12) Patent Application Publication
(10) Pub. No.: US 2017/0049121 A1
(43) Pub. Date: Feb. 23, 2017

(54) HIGH STEARIC HIGH OLEIC SHORTENING COMPOSITIONS AND METHODS OF MAKING AND USING THE SAME

(71) Applicant: Bunge Oils, Inc., St. Louis, MO (US)

(72) Inventors: Neil Wallace Higgins, Bourbonnais, IL (US); Vishal P. Jain, Tinley Park, IL (US); Dilip K. Nakhasi, Bourbonnais, IL (US); Eija Marjatta Piispa, Paimio (FI)

(73) Assignee: BUNGE OILS, INC., Saint Louis, MO (US)

(21) Appl. No.: 14/831,295

(22) Filed: Aug. 20, 2015

(51) Int. Cl. A23D 9/013

(52) U.S. Cl. CPC A23D 9/013

(57) ABSTRACT

Described herein are shortening compositions comprising a high stearic high oleic sunflower oil, a hard fat and optionally a cellulose fiber, wherein the hard fat is other than a palm fat.

### FIELD

Provided herein are shortening compositions comprising a high stearic high oleic sunflower oil, a hard fat and optionally a cellulose fiber, wherein the hard fat is other than a palm fat. Also provided are methods of preparing such compositions and uses thereof.

### BACKGROUND

There is a growing concern over the use of hydrogenated fats and palm fats in food products. For example, studies have linked used of palm oil to heart disease and cardiovascular disease. See Kabagambe et at., Baylin, A; Ascherio, A; Campos, H (November 2005). “The Type of Oil Used for Cooking Is Associated with the Risk of Nonfatal Acute Myocardial Infarction in Costa Rica”, Journal of Nutrition (135 ed.) (Journal of Nutrition) 135 (11): 2674-2679. PMID 16251629, and Chen et at. (2011) “Multi-Country analysis of palm oil consumption and cardiovascular disease mortality for countries at different stages of economic development: 1980-1997”, Globalization and Health 7(1): 45. doi:10.1186/1744-8603-7-45. PMC 3271960. PMID 22177258. According to Remig et at. in “Trans fats in America: a review of their use, consumption, health implications, and regulation”, J Am Diet Assoc. 2010 Apr;110(4):585-92, increasing epidemiologic and biochemical evidence suggest that excessive trans fats in the diet are a significant risk factor for cardiovascular events.

There is a continuing need for shortenings having reduced levels of palm fats and hydrogenated fats, and acceptable physical properties for handling and food preparation.

### SUMMARY

Provided herein are shortening compositions comprising a high stearic high oleic sunflower oil, a hard fat and optionally a cellulose fiber, wherein the hard fat is other than a palm fat. In certain embodiments, the hard fat is other than a hydrogenated hard fat.

In certain embodiments, provided herein are shortening compositions comprising a blend of an interesterified high stearic high oleic sunflower oil and a hard fat, wherein the composition has a Solid Fat Content (SFC) of about 20-30% at 10° C., the interesterified high stearic high oleic sunflower oil is obtained by directed interesterification of a high stearic high oleic sunflower oil, and the hard fat is other than a hydrogenated fat and a palm fat.

In certain embodiments, provided herein are shortening compositions comprising a high stearic high oleic sunflower oil interesterified with a hard fat by directed interesterification, wherein the composition has SFC of about 7-55% at 10° C. and the hard fat is other than a palm fat.

In certain embodiments, the interesterification is enzymatic or chemical directed interesterification.

In certain embodiments, the shortening compositions further comprise a cellulose fiber.

In certain embodiments, the hard fat is selected from coconut hard fat, shea butter, shea stearin and cottonseed hard fat.

In certain embodiments, the cellulose fibers are used in the compositions provided herein are used without hydrating with water, or treatment with other additives such as gums or emulsifiers. In certain embodiments, a shortening composition provided herein comprises less than about 1% water by weight based on total weight of the composition. In certain embodiments, the shortening composition provided herein comprises less than about 0.1%, 0.3%, 0.5%, 0.7%, 1%, 1.5%, 2%, 2.5%, or 3% water by weight based on total weight of the composition. The cellulose fibers having a range of average lengths, processed from different source materials and of different levels of purity can be used.

In another embodiment, provided herein is a method for preparing the shortening compositions described herein. In certain embodiments, the method of preparation comprises interesterifying a high stearic high oleic sunflower oil by directed interesterification to obtain an interesterified high stearic high oleic sunflower oil, and blending the interesterified high stearic high oleic sunflower oil with a hard fat, wherein the hard fat is other than a hydrogenated fat and a palm fat. The interesterification is enzymatic or directed chemical. In certain embodiments, the process further comprises blending a cellulose fiber.

In another embodiment, provided herein is a method for preparing the shortening compositions comprising interesterifying a high stearic high oleic sunflower oil and a hard fat by directed interesterification, wherein the hard fat is other than a palm fat. The interesterification is enzymatic or directed chemical. In certain embodiments, the process further comprises blending a cellulose fiber prior to after the interesterification step.

In certain embodiments, the shortenings so produced have lower levels of saturated fats and hydrogenated fats than the shortenings known in the art. In certain embodiment, the shortening compositions provided herein are used in bakery products, e.g., cookies, cakes, pie crusts, breads and other products in place of conventional partially hydrogenated shortenings.

It is to be understood that both the foregoing general description and the following detailed description are exemplary and explanatory only and are not restrictive.

### BRIEF DESCRIPTION OF DRAWINGS

FIG. 1 provides crystallization curve for compositions C-R21 and C-2 at 10° C.

FIG. 2 provides crystallization curve for compositions C-R22 and C-3 at 10° C.

FIG. 3 provides crystallization curve for compositions C-R23 and C-4 at 10° C.

FIG. 4 provides crystallization curve for compositions C-R17 and E-12 at 10° C.

FIG. 5 provides crystallization curve for compositions E-13 and C-16 at 10° C.

### DETAILED DESCRIPTION

Provided herein are shortening compositions comprising a high stearic high oleic sunflower oil, a hard fat and optionally a cellulose fiber, wherein the hard fat is other than a palm fat. Further provided are methods of making the compositions and uses of the compositions.

Definitions

Unless defined otherwise, all technical and scientific terms used herein have the same meaning as is commonly understood by one of ordinary skill in the art. All patents, applications, published applications and other publications are incorporated by reference in their entirety. In the event that there are a plurality of definitions for a term herein, those in this section prevail unless stated otherwise.

The term “plastic” as used herein is utilized to designate a shortening composition which is solid at room temperature.

The term “hydrogenated fat” as used herein refers to fully or partially hydrogenated oil(s), partial esters such as diglycerides and monoglycerides, waxes or mixtures thereof.

The term “hard fat” as used herein refers to a solid fraction of a fat, for example, stearin fraction.

The term “directed interesterification” as used herein refers to a process in which fatty acids in one or more triglycerides in at least two reactants are redistributed in a directed fashion to obtain a triglyceride product having a higher SFC content. Interesterification can be performed by chemical or enzymatic processes.

The term “directed intraesterification” as used herein refers to a process in which fatty acids in one or more triglycerides in an oil are redistributed in a directed fashion to obtain a triglyceride product having a higher SFC content. Intraesterification can be performed by chemical or enzymatic processes.

As used herein, “cellulose fiber” refers to a fibrous cellulose material obtained from plant sources. The fibrous nature of the material and the existence of capillaries that can take up oil is an important feature for the cellulose fiber used herein. Exemplary cellulose fibers are obtained from wood pulp, pea, bamboo, wheat, citrus and oat.

It must be noted that, as used in the specification and the appended claims, the singular forms “a,” “an” and “the” include plural referents unless the context clearly dictates otherwise. Thus, for example, reference to “a vegetable oil” includes mixtures of two or more such vegetable oils, and the like. In one embodiment, reference to “a vegetable oil” includes interesterified and/or genetically modified oils.

All percent values are given as weight percent unless expressly stated otherwise.

Compositions

In one embodiment, provided herein is a shortening composition comprising a blend of a intraesterified high stearic high oleic sunflower oil and a hard fat, wherein the intraesterified high stearic high oleic sunflower oil is obtained by directed intraesterification, and the hard fat is other than a palm fat. In one embodiment, the directed intraesterification is chemical directed intraesterification. In one embodiment, the intraesterification is enzymatic intraesterification.

In one embodiment, provided herein is a shortening composition comprising a directed interesterified blend of high stearic high oleic sunflower oil and a hard fat. In one embodiment, the directed interesterification is chemical directed interesterification. In one embodiment, the interesterification is enzymatic interesterification.

In one embodiment, the composition provided herein has an SFC of about 20-60% at 10° C. In one embodiment, the composition has an SFC of about 7-45% at 20° C. In one embodiment, the composition provided herein has an SFC of about 20-60% at 10° C. and SFC of about 7-45% at 20° C. In one embodiment, the composition has an SFC of about 4-20% at 30° C. In one embodiment, the composition has an SFC of about 3-15% at 35° C.

In one embodiment, the composition has an SFC profile as follows:

SFC at 10° C.: about 20-60%,

SFC at 20° C.: about 7-45%,

SFC at 30° C.: about 4-20%, and

SFC at 35° C.: about 3-15%.

In one embodiment, the composition provided herein has an SFC of about 20-30% at 10° C. In one embodiment, the composition has an SFC of about 15-20% at 20° C. In one embodiment, the composition provided herein has an SFC of about 20-30% at 10° C. and SFC of about 15-20% at 21° C.

In one embodiment, the composition has an SFC profile as follows:

SFC of about 20-30% at 10° C.,

SFC of about 15-20% at 21° C.,

SFC of about 13-15% at 26.7° C., and

SFC of about 10-15% at 33.3° C.

In one embodiment, the intraesterified high stearic high oleic sunflower oil has an SFC of about 20-25% at 10° C. In one embodiment, the intraesterified high stearic high oleic sunflower oil has an SFC of about 15-20% at 21° C. In one embodiment, the intraesterified high stearic high oleic sunflower oil has an SFC of about 20-25% at 10° C. and SFC of about 15-20% at 21° C. In one embodiment, the intraesterified high stearic high oleic sunflower oil has an SFC of about 10-15% at 33° C.

In one embodiment, the intraesterified high stearic high oleic sunflower oil has an SFC profile as follows:

SFC of about 20-25% at 10° C.,

SFC of about 15-20% at 21° C.,

SFC of about 13-15% at 26.7° C., and

SFC of about 10-15% at 33.3° C.

In one embodiment, the intraesterified high stearic high oleic sunflower oil has an SFC of about 14-20% at 10° C. In one embodiment, the intraesterified high stearic high oleic sunflower oil has an SFC of about 11-15% at 20° C. In one embodiment, the intraesterified high stearic high oleic sunflower oil has an SFC of about 14-20% at 10° C. and SFC of about 11-15% at 20° C. In one embodiment, the intraesterified high stearic high oleic sunflower oil has an SFC of about 8-11% at 33° C.

In one embodiment, the intraesterified high stearic high oleic sunflower oil has an SFC profile as follows:

SFC at 10° C.: about 14-20%,

SFC at 20° C.: about 11-15%,

SFC at 27° C.: about 10-13%, and

SFC at 33° C.: about 8-11%.

In one embodiment, the intraesterified high stearic high oleic sunflower oil has an SFC profile as follows:

SFC at 10° C.: about 15-18%,

SFC at 21° C.: about 11-15%,

SFC at 27° C.: about 10-13%, and

SFC at 33° C.: about 8-11%.

In certain embodiments, the total amount of the intraesterified high stearic high oleic sunflower oil used in the compositions provided herein is at least 25% by weight based on the total weight of the composition. In certain embodiments, the total amount of the intraesterified high stearic high oleic sunflower oil used in the compositions provided herein is at least 25%, 35%, 40%, 45%, 50%, or 55% by weight based on the total weight of the composition. In certain embodiments, the total amount of the intraesterified high stearic high oleic sunflower oil used in the compositions provided herein is from about 20-70% by weight based on the total weight of the composition. In certain embodiments, the total amount of the intraesterified high stearic high oleic sunflower oil used in the compositions provided herein is from about 30-60% by weight based on the total weight of the composition. In certain embodiments, the total amount of the intraesterified high stearic high oleic sunflower oil used in the compositions provided herein is from about 45-55% by weight based on the total weight of the composition. In certain embodiments, the total amount of the intraesterified high stearic high oleic sunflower oil used in the compositions provided herein is about 25, 30, 35, 40, 45, 50, 55, 60 or 65% by weight based on the total weight of the composition.

In certain embodiments, provided herein are shortening compositions comprising a high stearic high oleic sunflower oil interesterified with a hard fat by enzymatic interesterification, wherein the composition has an SFC of about 10-30% at 10° C., and the hard fat is other than a palm fat. In certain embodiments, the compositions further comprise about 0.5-3% fully hydrogenated rapeseed oil. In one embodiment, the composition has an SFC of about 1-16% at 20° C.

In certain embodiments, provided herein are shortening compositions comprising a high stearic high oleic sunflower oil interesterified with a hard fat by directed chemical interesterification, wherein the composition has an SFC of about 7-55% at 10° C., and the hard fat is other than a palm fat. In certain embodiments, the compositions further comprise about 0.5-3% fully hydrogenated rapeseed oil. In one embodiment, the composition has an SFC of about 1-45% at 20° C.

In certain embodiments, the total amount of the high stearic high oleic sunflower oil used in the compositions provided herein is at least 25% by weight based on the total weight of the composition. In certain embodiments, the total amount of the high stearic high oleic sunflower oil used in the compositions provided herein is at least 25%, 35%, 40%, 45%, 50%, or 55% by weight based on the total weight of the composition. In certain embodiments, the total amount of the high stearic high oleic sunflower oil used in the compositions provided herein is from about 20-70% by weight based on the total weight of the composition. In certain embodiments, the total amount of the high stearic high oleic sunflower oil used in the compositions provided herein is from about 30-60% by weight based on the total weight of the composition. In certain embodiments, the total amount of the high stearic high oleic sunflower oil used in the compositions provided herein is from about 45-55% by weight based on the total weight of the composition. In certain embodiments, the total amount of the high stearic high oleic sunflower oil used in the compositions provided herein is about 25, 30, 35, 40, 45, 50, 55, 60 or 65% by weight based on the total weight of the composition.

In certain embodiments, the hard fat used in the compositions provided herein is selected from one or more of coconut hard fat, shea butter and shea stearin.

In certain embodiments, the total amount of the hard fat used in the compositions provided herein is from about 20-60% by weight based on the total weight of the composition. In certain embodiments, the total amount of the hard fat used in the compositions provided herein is from about 25-55% by weight based on the total weight of the composition. In certain embodiments, the total amount of the hard fat used in the compositions provided herein is from about 25-50% by weight based on the total weight of the composition. In certain embodiments, the total amount of the hard fat used in the compositions provided herein is about 25, 30, 35, 40, 45, 50 or 55% by weight based on the total weight of the composition.

In certain embodiment, the cellulose fibers are used in the compositions without hydrating with water, or treatment with other additives such as gums or emulsifiers. In certain embodiments, the shortening composition provided herein comprises less than about 0.1%, 0.3%, 0.5%, 0.7% or 1% water by weight based on total weight of the composition. The cellulose fibers having a range of average lengths, processed from different source materials and of different levels of purity can be used. In certain embodiments, the shortening composition provided herein comprises less than about 1% water by weight based on total weight of the composition.

In certain embodiments, the cellulose fibers for use herein are obtained from plant sources, including but not limited to wood pulp, bamboo, pea, citrus fruit and sugar beets. In certain embodiments, the cellulose fibers used herein include, UPTAKE 80, and CENTU-TEX, CeREAFill produced by Norben Company, Inc., CREAFIBE QC 150, and CREACLEAR SC 150 produced by CREAFILL Fibers Corp., and SOLKA FLOC® 900 FCC, SOLKA FLOC® 300 FCC, SOLKA FLOC® 40 FCC, JUSTFIBEROC4OFCC produced by International Fiber Corporation and RIDGELANDO Fiber PC-200. Exemplary cellulose fibers are described in U.S. Pat. Nos. 8,394,445 and 8,486,479. In certain embodiments, the cellulose fibers have an average fiber length of about 75-400 micron, 85-400 micron, 100-400 micron, 100-350 micron, or 110-350 micron. In certain embodiments, the cellulose fibers have an average fiber length of about 110-350 micron. In certain embodiments, the cellulose fibers have an average fiber length of about 115, 120 or 300 micron. In certain embodiments, the cellulose fibers are obtained from an algal source. Any cellulose material having fibrous nature and capillaries that can take up oil can be used in the compositions provided herein.

In certain embodiments, the compositions provided herein comprise the cellulose fiber in an amount from about 1 to about 15% by weight based on the total weight of the composition. In certain embodiments, the amount of the cellulose fiber in the compositions is about 1%-10%, about 1%-7%, about 1%-4%, about 2%-10%, about 2%-7%, or about 2%-5% by weight based on the total weight of the composition. In certain embodiments, the amount of the cellulose fiber in the compositions is about 3%-5% or about 4%-5% by weight based on the total weight of the composition. In certain embodiments, the amount of the cellulose fiber in the compositions is about 1, 2, 3, 4, 5, 6, 7, 8, 9, 10, 11, 12, 13, 14 or 15% by weight based on the total weight of the composition. In certain embodiments, the amount of the cellulose fiber in the compositions is about 3, 4, 4.5, 5, 6 or 7% by weight based on the total weight of the composition.

The cellulose fibers are used in the compositions without hydrating with water, or treatment with other additives such as gums or emulsifiers. In certain embodiments, a shortening composition provided herein comprises less than about 1% water by weight based on total weight of the composition. In certain embodiments, the shortening composition provided herein comprises less than about 0.1%, 0.3%, 0.5%, 0.7%, 1%, 1.5%, 2%, 2.5%, or 3% water by weight based on total weight of the composition. The cellulose fibers having a range of average lengths, processed from different source materials and of different levels of purity can be used.

In certain embodiments, the compositions provided herein further comprise one or more additives. Common additives that can be added to the shortening compositions provided herein include, but are not limited to stabilizers, flavoring agents, emulsifiers, anti-spattering agents, colorants, or antioxidants. Exemplary additives are described, for example, in Campbell et at., Food Fats and Oils, 8th Ed., Institute of Shortening and Edible Oils, Washington, D.C.

In certain embodiments, the shortening formulations further comprise an antioxidant. A wide variety of antioxidants are suitable for use, including but not limited to butylated hydroxytoluene (BHT), butylated hydroxyanisole (BHA), tertiary butylhydroquinone (TBHQ), ethylenediaminetetracetic acid (EDTA), gallate esters (i.e. propyl gallate, butyl gallate, octyl gallate, dodecyl gallate, etc.), tocopherols, citric acid, citric acid esters (i.e. isopropyl citrate, etc.), gum guaiac, nordihydroguaiaretic acid (NDGA), thiodipropionic acid, ascorbic acid, ascorbic acid esters (i.e. ascorbyl palmitate, ascorbyl oleate, ascorbyl stearate, etc.) tartaric acid, lecithin, methyl silicone, polymeric antioxidant (Anoxomer) plant (or spice and herb) extracts (i.e. rosemary, sage, oregano, thyme, marjoram, etc.) and mixtures thereof.

In certain embodiments, the shortening formulations further comprise an emulsifier. A wide variety of emulsifiers are suitable for use, including but not limited to mono- and diglycerides, distilled monoglycerides, polyglycerol esters of C₁₂ to C₂₂ fatty acids, propylene glycol mono and diesters of C₁₂ to C₂₂ fatty acids, sucrose mono- and diesters of C₁₄ to C₂₂ fatty acids.

In certain embodiments, the shortening formulations further comprise additional ingredients, such as butter flavors, meat or tallow flavors, olive oil flavors and other natural or synthetic flavors. In certain embodiments, vitamins can be included in the compositions provided herein. In certain embodiments, various other additives can be used in the shortenings provided that they are edible and aesthetically desirable.

Methods of Preparation

In certain embodiments, the methods of preparation comprise blending an intraesterified high stearic high oleic sunflower oil and a hard fat to obtain a shortening formulation having an SFC of about 25-60% at 10° C., wherein the hard fat is other than a hydrogenated fat and a palm fat. In certain embodiments, the process further comprises intraesterifying the high stearic high oleic sunflower oil by directed intraesterification.

In certain embodiments, the methods of preparation comprise interesterifying a high stearic high oleic sunflower oil and a hard fat by directed interesterification to obtain a shortening formulation, wherein the hard fat is other than a hydrogenated fat and a palm fat.

The directed interesterification can be an enzymatic or a chemical directed interesterification. Suitable reagents and reaction conditions for directed interesterification are known in the art. For example, enzymatic interesterification reactions are described in U.S. Pat. No. 8,153,391 and MacKenzie et at. Enzyme Microb Technol. 2000 Aug 1; 27(3-5):302-311. Exemplary methods for chemical directed interesterification are described in U.S. Pat. Nos. 4,791,000; 3,855,254; and 2,442,531, Dijkstra Edible Oil Processing, Chemical Interesterification, AOCS 2011; Marangoni et at., 1995, “Engineering Triacylglycerols: The Role of Interesterification” Trends in Food Science & Technology, (10) 329-335.

In one embodiment, the interesterification is an enzymatic interesterification and the shortening formulation has an SFC of about 7-55% at about 10° C. In one embodiment, the directed interesterification is a chemical interesterification and the shortening formulation has an SFC of about 1-45% at about 10° C.

In certain embodiment, the process further comprises blending a cellulose fiber in the composition. The blending step can be performed before or after the interesterification. During the blending step, the composition is brought to a molten state such that mixture becomes homogenized. The order of adding the ingredients and heating the ingredients can be changed as required by a particular process. The ingredients can be added at ambient temperature, or at a higher temperature, depending on the particular system used, and it is intended that the claims appended hereto shall not be limited by the order of the heating and mixing steps. The molten homogeneous composition is cooled, in one embodiment, with agitation, to promote a crystal structure that imparts the desired physical properties to the shortening. A heat exchanger, in one embodiment, a scraped surface heat exchanger, can provide the desired cooling with agitation.

In certain embodiments, a mechanical agitator is used to agitate the compositions during the process. In certain embodiments, agitation is achieved by means of a scraped-surface heat exchanger known in the art of shortening manufacture. In certain embodiments, processing conditions within the scraped-surface heat exchanger can be adjusted to further promote the desired shortening properties. The scraper blades prevent any build-up on the cylinder of crystals and other large particulates that can reduce thermal exchange and increase run time. A number of different operating parameters in the scraped-surface heat exchanger can be modified in order to optimize the one or more properties of the shortening (e.g., hardness, melting). For example, the speed of the scraping blades, the pumping speed through the scraped surface heat exchanger, and the exit temperature from the heat exchanger can be modified to optimize the hardness of the shortening, which is shown in the working examples below.

The shortenings produced herein can be used to produce a variety of foods including, but not limited to, popcorns baked goods, an icing, biscuits, bread, a pie crust, a danish, a croissant, or a pastry puff With the reduction in total saturated and trans fat content, food products produced with the shortenings described herein can provide health benefits. Furthermore, the use of directed interesterification and/or directed intraesterification techniques in compositions containing HSHO oils allows reduction in the levels of saturated fatty acids (SAFA) and hydrogenated fats while providing the desired crystal structure for the compositions.

The following examples present certain exemplary embodiments and are intended by way of illustration and not by way of limitation. In each of the examples herein, percentages indicate weight percent of the total mixture, unless otherwise indicated.

### EXAMPLES

The following examples are put forth so as to provide those of ordinary skill in the art with a complete disclosure and description of how the compounds, compositions, and methods described and claimed herein are made and evaluated, and are intended to be purely exemplary and are not intended to limit the scope of the claimed subject matter. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures and other reaction ranges and conditions that can be used to optimize the product purity and yield obtained from the described process. Only reasonable and routine experimentation will be required to optimize such process conditions.

### Example 1

### Directed Vs. Random Intraesterification of High Oleic and High Stearic Sunflower Oil

About 1200 grams of sunflower oil characterized as high oleic and high stearic acid was subjected to a directed chemical intraesterification at about 28° C. About 0.5% sodium methoxide catalyst (based upon oil weight) was introduced to the oil at about 80° C. and mixed with high shear agitation (Silverson Mixer at 3000 RPM) for about 30 minutes. The agitation was stopped and the oil was cooled to about 28° C. The catalyst was neutralized about 72 hours after catalyst addition with about 1.67% (based on oil weight) of a about 50% citric acid solution. After the citric acid solution was mixed into a soft solid mass; the temperature of the circulating water was raised to about 80° C. with continuing agitation. When the mass softened enough, the high shear mixer was used for 10 minutes to finish dispersing the neutralizing solution.

In the post reaction treatment, the oil was treated with 1.0% Trisyl S-615 (silica material) and 1.0% filter-aid at 90-94° C., mixed well for 5-10 minutes and filtered to remove all the soaps.

The oil from post-reaction treatment was bleached with 0.5% of bleaching earth and 0.5% of filter-aid to remove all the color bodies, if needed and deodorized. The deodorization was conducted by heating at the temperature of 226.7°-232.2° C., under vacuum (2.66 mbar (2 mm Hg)) with 0.4% steam/hour for 4 hours.

Another lot was also made using the same methodology. The two lots were combined and deodorized together. The deodorized oil had the following SFC (solid fat content profile):

| | |
|---|---|
| SFC 10.0° C. | 16.29% |
| SFC 21.1° C. | 12.84% |
| SFC 26.7° C. | 11.91% |
| SFC 33.3° C. | 9.57% |
| SFC 40.0° C. | 6.73% |

The deodorized oil had the following fatty acid methyl ester profile:

| | |
|---|---|
| C16:0 | 4.79 |
| C16:1 | 0.09 |
| C18:0 | 16.35 |
| C18:1 | 70.35 |
| C18:1 T | 0.40 |
| C18:2 T | 0.82 |
| C18:2 | 3.37 |
| C20:0 | 1.31 |
| C20:1 | 0.12 |
| C22:0 | 2.03 |
| C24:0 | 0.36 |

This deodorized oil was split into two portions for bench top crystallization techniques which were conducted with and without 4.5% of cellulose fiber (Solka Floc 900, International Fiber Corporation) respectively. Following observations were noticed upon initial filling into a 32 oz. class jars, the material with the cellulose was softer than that without. Following 17 hours storage at about 70° F. texture measurements were taken using a TA-XTZ Texture Analyzer (Stable Micro Systems). Using the following parameters:

| | |
|---|---|
| Probe | 5 mm Stainless Steel Probe |
| Test Type | measure fore in compression, return to start |
| Pretest Speed | 1 mm/s |
| Test Speed | 3 mm/s |
| Post Test Speed | 5 mm/s |
| Distance | 20 mm |
| Trigger Type | Auto |
| Acquisition Rate | 200 PPS. |

Texture readings on directed interesterified HSHO sunflower oil alone was 278.4 g average of two readings while the directed rearranged HSHO sunflower oil plus fiber was 339.5 g average of two readings. This difference in texture is readily felt when handling the shortening with the firmer being closer to the texture of shortening as made using a base oil which had been partially hydrogenated.

Upon random intraesterification of HSHO sunflower oil, the resulting oil had the following SFC (solid fat content profile):

| | |
|---|---|
| SFC 10° C. | 5.3% |
| SFC 20° C. | 0% |
| SFC 30° C. | 0% |
| SFC 35° C. | 0% |
| SFC 40° C. | 0% |

The directed intraesterified HSHO sunflower oil was used in Compositions N1-N7 and N11-N16 described in Example 2.

### Example 2

Compositions N-1 to N-7 were prepared by physically blending components selected from: directed intraesterified HSHO sunflower oil and a hard fat selected from shea butter, shea stearin and coconut hard fat in the amounts described in Table 1.

TABLE 1

| | dCIE | | | |
|---|---|---|---|---|
| | HSHO | | | |
| | Sunflower | Shea | Shea | Coconut |
| Sample No. | Oil | butter | stearin | hardfat |
| N-1 | 100% | | | |
| N-2 | 75% | 25% | | |
| N-3 | 50% | 50% | | |
| N-4 | 75% | | 25% | |
| N-5 | 50% | | 50% | |
| N-6 | 75% | | | 25% |
| N-7 | 50% | | | 50% |

Compositions N-11 to N-16 were prepared by blending components selected from: directed intraesterified HSHO sunflower oil and a hard fat selected from shea butter, shea stearin and coconut hard fat in the amounts described in Table 2.

TABLE 2

| | dCIE | | | |
|---|---|---|---|---|
| | HSHO | | | |
| | Sunflower | Shea | Shea | Coconut |
| Sample No. | Oil | butter | stearin | hardfat |
| N-11 | 50% | 25% | | 25% |
| N-12 | 75% | 12.5% | | 12.5% |
| N-13 | 50% | | 25% | 25% |
| N-14 | 75% | | 12.5% | 12.5% |
| N-15 | 50% | | | |
| N-16 | 75% | | | |

Compositions E-1 to E-7 were prepared by blending components selected from: HSHO sunflower oil, a small amount of fully hydrogenated low erucic acid rapeseed oil (FH Rapeseed) and a hard fat selected from shea butter, shea stearin and coconut hard fat to obtain a fat blend, and interesterifying the fat blend in an enzymatic interesterification process. The amounts of various fats are described in Table 4.

The conditions for enzymatic interesterification of HSHO sunflower oil and are described in Table 3.

TABLE 3
EIE conditions

| | | | | Retention time | | | | |
|---|---|---|---|---|---|---|---|---|
| | Added | Temp. | | (reaction done | | | | Controlled |
| Protocol (EIE): | material | ° C. | Dosage | under mixing) | | Pressure | | parameters |
| Heating/drying | — | 80° C. | — | | | 10 | mbar | Water content |
| of fat blend | | | | | | | | (<50 mg/kg) |
| Enzyme | — | 70° C. | 5.00% | 30 | min | 20 | mbar | Temp |
| (Lipozyme TL | | | | | | | | |
| IM) preparation - | | | | | | | | |
| drying | | | | | | | | |
| Interesterification - | — | 70° C. | — | 8 | hours | 100 | mbar | Temp |
| enzymatic | | | | | | | | |
| Deodorization | N₂/H₂O | 235° C. | 5 ml/h/kg | 2 | hours | 2 | mbar | Free fatty acids |

TABLE 4
Fat ratios

| | HSHO | | | | |
|---|---|---|---|---|---|
| | Sunflower | Shea | Shea | Coconut | FH |
| Sample No. | Oil | butter | stearin | hardfat | Rapeseed |
| E-1 | 97.5% | | | | 2.5% |
| E-2 | 73.12% | 25% | | | 1.88% |
| E-3 | 48.75% | 50% | | | 1.25% |
| E-4 | 73.12% | | 25% | | 1.88% |
| E-5 | 48.75% | | 50% | | 1.25% |
| E-6 | 73.12% | | | 25% | 1.88% |
| E-7 | 48.75% | | | 50% | 1.25% |

Compositions E-11 to E-22 were prepared by blending components selected from: regular sunflower oil, HSHO sunflower oil, a small amount of fully hydrogenated rapeseed oil and a hard fat selected from shea butter, shea stearin and coconut hard fat to obtain a fat blend. The fat blend was interesterified an enzymatic interesterification process using the protocol described in Table 3. The amounts of various fats are described in Table 5.

TABLE 5

| | Regular | HSHO | | | | |
|---|---|---|---|---|---|---|
| Sample | Sunflower | Sunflower | Shea | Shea | Coconut | FH |
| No. | Oil | Oil | butter | stearin | hardfat | Rapeseed |
| E-11 | | 97.65% | | | | 2.35% |
| E-12 | | 73.24% | 12.5% | | 12.5% | 1.76% |
| E-13 | | 48.82% | 25% | | 25% | 1.18% |
| E-14 | | 73.24% | | 12.5% | 12.5% | 1.76% |
| E-15 | | 48.82% | | 25% | 25% | 1.18% |
| E-16 | | 73.24% | | | 25.0% | 1.76% |
| E-17 | | 48.82% | | | 50.0% | 1.18% |
| E-R20 | 50% | | 50% | | | |
| E-R21 | 50% | | | 50% | | |
| E-R22 | 50% | | | | 50% | |

Compositions C-1 to C-6 were prepared by blending components selected from: HSHO sunflower oil, a small amount of fully hydrogenated rapeseed oil and a hard fat selected from shea butter, shea stearin, coconut hard fat and cottonseed hard fat to obtain a fat blend. The fat blend was directed interesterifled in a chemical interesterification using a procedure similar to the procedure described in Example 1.

Cottonseed oil being liquid oil, but containing 27% saturated fat, mainly palmitic acid C16:0 (86% of saturated is palmitic acid) was used as to compare with HSHO in order to see differences of stearic and palmitic acid in esterification process.

The amounts of various fats are described in Table 6.

TABLE 6

| Sample | | Shea | Shea | Coconut | Cottonseed | FH |
|---|---|---|---|---|---|---|
| No. | HSHO | butter | stearin | oil | oil | Rapeseed |
| C-1 | 97.5% | | | | | 2.5% |
| C-2 | 48.75% | 50% | | | | 1.0% |
| C-3 | 48.75% | | 50% | | | 1.25% |
| C-4 | 48.75% | | | 50% | | 1.25% |
| C-5 | 73.12% | | | | 25% | 1.88% |
| C-6 | 48.75% | | | | 50% | 1.25% |

Compositions C-11 to C-23 were prepared by blending components selected from: HSHO sunflower oil, a small amount of fully hydrogenated rapeseed oil and a hard fat selected from shea butter, shea stearin, coconut hard fat and cottonseed hard fat, to obtain a fat blend, and directed interesterifying the fat blend in a chemical interesterification process. The amounts of various fats are described in Table 7.

TABLE 7

| | Regular | HSHO | | | | |
|---|---|---|---|---|---|---|
| Sample | Sunflower | Sunflower | Shea | Shea | Coconut | FH |
| No. | Oil | Oil | butter | stearin | hardfat | Rapeseed |
| C-11 | | 97.65% | | | | 2.0% |
| C-12 | | 73.82% | 25% | | | 1.0% |
| C-13 | | 73.82% | | 25% | | 2.35% |
| C-14 | | 73.82% | | | 25% | 1.18% |
| C-16 | | 48.82% | 25% | | 25.0% | 1.18% |
| C-17 | | 73.24% | 12.5% | | 12.5% | 1.76% |
| C-18 | | 48.82% | | 25.0% | 25.0% | 1.18% |
| C-19 | | 73.24% | | 12.5% | 12.5% | 1.76% |
| C-21 | 50% | | 50% | | | |
| C-22 | 50% | | | 50% | | |
| C-23 | 50% | | | | 50% | |

Blend Analysis—Solid Fat Content

The compositions were characterized using Bruker NMR minispec mq20 SFC analyser. An SFC value was determined by detecting the NMR signal from both liquid and solid components in the fat sample simultaneously, since the signals from the liquid and the solid parts differ, the SFC as a function of sample temperature could be obtained directly. The Brucker minispec was calibrated before starting the analysis, the daily check procedure was tested (check the equipment by means of the Bruker SFC standards) for the proper system performance and repeated after every 24h.

Samples were transferred to the tubes, each filled with 2 ml of the blend. Tubes were melted and tempered according to the pattern described in Table 8. Tempering and measuring were done parallel.

TABLE 8
Tempering temperature pattern for the Compositions

| Step | Time (min) | Temperature (° C.) |
|---|---|---|
| Melting | 10 | 70-80 |
| Tempering | 10 | 60 |
| Tempering | 60 | 0 |
| Tempering | 30 | 10, 20, 30, 35 and 40 |

SFC profiles of the samples is provided in Table 9.

TABLE 9

| | Temperature (° C.) | | | | |
|---|---|---|---|---|---|
| | 10 | 20 | 30 | 35 | 40 |
| Sample ID | Solid Fat Content (%) | | | | |
| N-1 | 19.2 | 14.9 | 11.8 | 10.6 | 8.6 |
| N-2 | 28.9 | 19.3 | 12.2 | 10.0 | 7.6 |
| N-3 | 30.5 | 17.4 | 9.7 | 7.2 | 5.2 |
| N-4 | 41.2 | 27.7 | 15.2 | 11.8 | 8.3 |
| N-5 | 55.5 | 40.7 | 15.2 | 10.2 | 6.6 |
| N-6 | 26.4 | 12.1 | 9.4 | 8.0 | 5.9 |
| N-7 | 35.1 | 8.9 | 5.5 | 4.7 | 3.3 |
| E-1 | 5.2 | 2.3 | 1.0 | 0.2 | 0.3 |
| E-2 | 10.7 | 5.6 | 2.3 | 1.4 | 0.3 |
| E-3 | 11.2 | 6.7 | 3.7 | 3.2 | 1.4 |
| E-4 | 16.1 | 8.3 | 3.9 | 3.0 | 1.1 |
| E-5 | 24.6 | 14.4 | 10.1 | 7.5 | 4.9 |
| E-6 | 17.9 | 3.3 | 0.1 | 0.2 | 0.3 |
| E-7 | 27.1 | 2.4 | 0 | 0.3 | 0.2 |
| C-1 | 20.1 | 14.9 | 11.3 | 9.5 | 7.5 |
| C-2 | 17.1 | 13.9 | 9.5 | 7.0 | 4.1 |
| C-3 | 50.2 | 41.1 | 32.0 | 26.7 | 21.3 |
| C-4 | 25.6 | 1.8 | 0.8 | 0.7 | 0.0 |
| C-5 | 10.9 | 5.0 | 2.2 | 1.4 | 0.2 |
| C-6 | 8.3 | 4.3 | 1.706 | 0.884 | 0.4 |

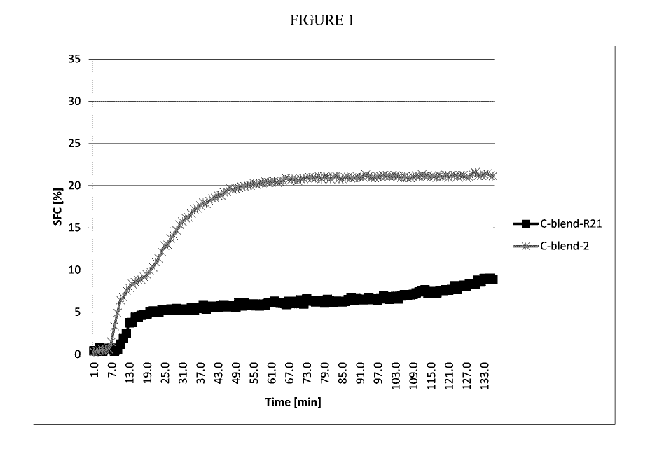

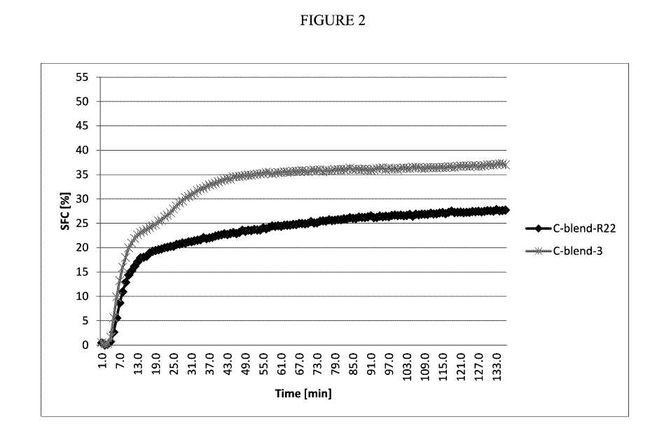

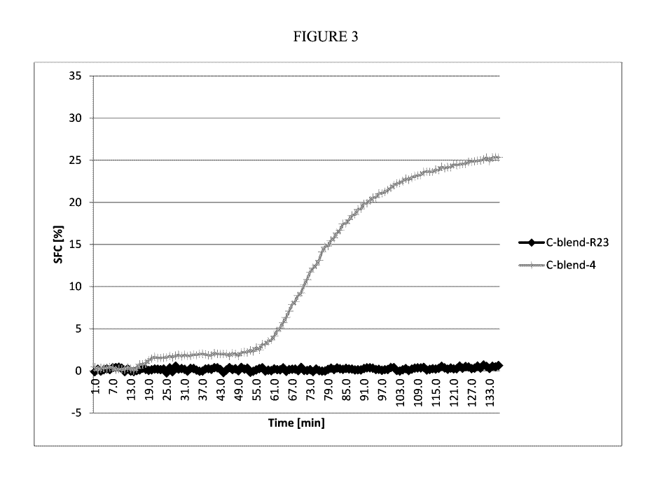

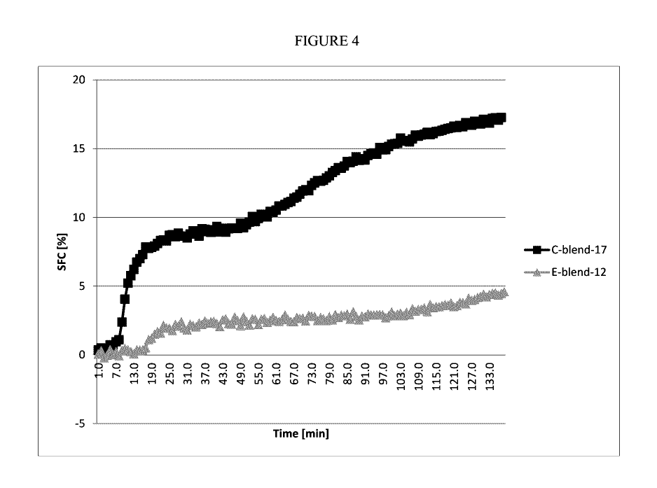

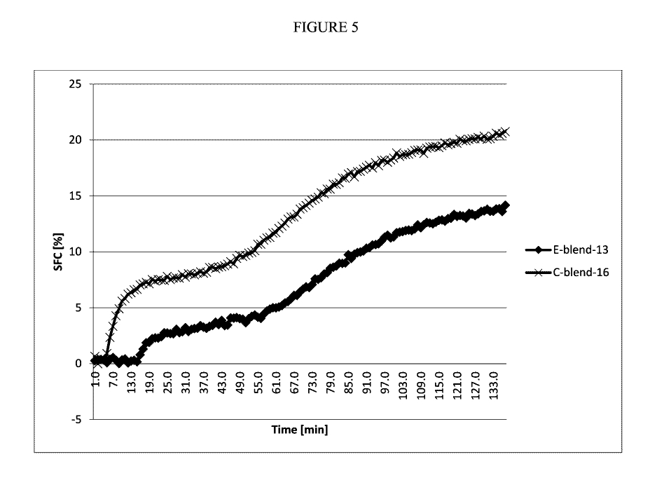

FIGS. 1-5 provide crystallization curves for exemplary compositions at 10° C. As seen from the crystallization curves, the compositions containing directed intraesterifled high oleic high stearic sunflower oil as such or blended with hard fats as described in example 2, Tables 1-6 and/or compositions wherein the fat components are blended followed by chemical directed interesterification provide the desired SFC profile.

Blend Analysis—Crystallization Kinetics Studies

The crystallization pattern for fat compositions in Table 1 was measured using a temperature controlled Bruker NMR minispec mq20 SFC analyser. The Brucker minispec was calibrated before starting the analysis, the daily check procedure was tested (check the equipment by means of the Bruker SFC standards) for the proper system performance and repeated after every 24h.

Two ml of the samples were introduced in tubes. Tubes were tempered according to the pattern provided in Table 10. Tempering and measuring were done in serial for each of the temperatures.

TABLE 10

| Step | Time (min) | Temperature (° C.) |
|---|---|---|
| Melting | 10 | 80 |
| Tempering | 30 | 60 |
| Measuring | 60 | NMR: 0, 10 and 20 |

The crystallization curves from analysis in 10° C. for the samples are provided in FIGS. 1-5.

Throughout this application, various publications are referenced. The disclosures of these publications in their entireties are hereby incorporated by reference into this application in order to more fully describe the compounds, compositions and methods described herein.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

What is claimed is:

1. A shortening composition comprising a blend of an intraesterified high stearic high oleic sunflower oil and a hard fat, wherein the intraesterified high stearic high oleic sunflower oil is obtained by directed intraesterification of high stearic high oleic sunflower oil, the hard fat is other than a hydrogenated fat and a palm fat and the composition has a solid fat content of about 20-30% at 10° C.

2. The shortening composition of claim 1, wherein the composition has a solid fat content of about 12-22% at 21° C.

3. The shortening composition of claim 1, wherein the composition has a solid fat content of about 13-15% at 26.7° C.

4. The shortening composition of claim 1, wherein the composition has a solid fat content of about 10-15% at 33.3° C.

5. The shortening composition of claim 1, wherein the composition has a solid fat content profile as follows:
SFC of about 20-30% at 10° C.,
SFC of about 12-22% at 21° C.,
SFC of about 13-15% at 26.7° C., and
SFC of about 10-15% at 33.3° C.

6. The shortening composition of claim 1, wherein the composition has a solid fat content profile as follows:
SFC of about 20-25% at 10° C.,
SFC of about 15-20% at 21° C.,
SFC of about 13-15% at 26.7° C., and
SFC of about 10-15% at 33.3° C.

7. The shortening composition of claim 1, wherein the composition further comprises a cellulose fiber.

8. The shortening composition of claim 7, wherein the cellulose fiber is present in an amount from about 1 to 15% by weight based on the total weight of the composition.

9. The shortening composition of claim 1, wherein the total amount of intraesterified high stearic high oleic sunflower oil used in the compositions provided herein is at least 25% by weight based on the total weight of the composition.

10. The shortening composition of claim 1, wherein the intraesterified high stearic high oleic sunflower oil has a solid fat content of about 10-30% at 10° C.

11. The shortening composition of claim 1, wherein the hard fat is selected from coconut hard fat, shea butter, shea stearin and a mixture thereof.

12. A shortening composition comprising a high stearic high oleic sunflower oil and a hard fat, wherein the high stearic high oleic sunflower oil is interesterified with the hard fat by enzymatic interesterification, the hard fat is other than a palm fat, and the composition has a solid fat content of about 20-30% at 10° C.

13. The shortening composition of claim 12, wherein the composition has a solid fat content of about 15-20% at 21° C.

14. The shortening composition of claim 12, wherein the composition has a solid fat content of about 13-15% at 26.7° C.

15. The shortening composition of claim 12, wherein the composition has a solid fat content of about 10-15% at 33.3° C.

16. The shortening composition of claim 12, wherein the composition has a solid fat content profile as follows:
SFC of about 20-30% at 10° C.,
SFC of about 15-20% at 21° C.,
SFC of about 13-15% at 26.7° C., and
SFC of about 10-15% at 33.3° C.

17. The shortening composition of claim 12, wherein the composition has a solid fat content profile as follows:
SFC of about 20-25% at 10° C.,
SFC of about 15-20% at 21° C.,
SFC of about 13-15% at 26.7° C., and
SFC of about 10-15% at 33.3° C.

18. The shortening composition of claim 12 further comprising about 0.5 to 3% fully hydrogenated rapeseed oil.

19. The shortening composition of claim 12, wherein the hard fat is selected from coconut hard fat, shea butter, shea stearin, cottonseed hard fat and a mixture thereof.

20. A shortening composition comprising a high stearic high oleic sunflower oil and a hard fat, wherein the high stearic high oleic sunflower oil is interesterifled with the hard fat by directed chemical interesterification, the hard fat is other than a palm fat, and the composition has a solid fat content of about 20-30% at 10° C.

21. The shortening composition of claim 20, wherein the composition has a solid fat content of about 15-20% at 21° C.

22. The shortening composition of claim 20, wherein the composition has a solid fat content of about 13-15% at 26.7° C.

23. The shortening composition of claim 20, wherein the composition has a solid fat content of about 10-15% at 33.3° C.

24. The shortening composition of claim 20, wherein the composition has a solid fat content profile as follows:
SFC of about 20-30% at 10° C.,
SFC of about 15-20% at 21° C.,
SFC of about 13-15% at 26.7° C., and
SFC of about 10-15% at 33.3° C.

25. The shortening composition of claim 20, wherein the composition has a solid fat content profile as follows:
SFC of about 20-25% at 10° C.,
SFC of about 15-20% at 21° C.,
SFC of about 13-15% at 26.7° C., and
SFC of about 10-15% at 33.3° C.

26. The shortening composition of claim 20 further comprising about 0.5 to 3% fully hydrogenated rapeseed oil.

27. The shortening composition of claim 20, wherein the hard fat is selected from coconut hard fat, shea butter, shea stearin, cottonseed hard fat and a mixture thereof.

28. The shortening composition of claim 1, wherein the hard fat is present in an amount from about 25 to about 50% by weight based on total weight of the composition.

29. The shortening composition of claim 12, wherein the hard fat is present in an amount from about 25 to about 50% by weight based on total weight of the composition.

30. The shortening composition of claim 20, wherein the hard fat is present in an amount from about 25 to about 50% by weight based on total weight of the composition.

31. A food product comprising the shortening composition of claim 1.

32. A food product comprising the shortening composition of claim 12.

33. A food product comprising the shortening composition of claim 20.

34. A method of preparing the shortening composition of claim 1, wherein the method comprises mixing an intraesterified high stearic high oleic sunflower oil and a hard fat to obtain the shortening composition, the intraesterified high stearic high oleic sunflower oil is obtained by directed intraesterification, and the hard fat is other than a hydrogenated fat and a palm fat.

35. The method of claim 34, wherein the intraesterified high stearic high oleic sunflower oil is obtained by directed chemical intraesterification.

36. The method of claim 34, wherein the intraesterified high stearic high oleic sunflower oil is obtained by enzymatic intraesterification.

37. A method of preparing the shortening composition of claim 12, wherein the method comprises an enzymatic interesterification of a high stearic high oleic sunflower oil and a hard fat other than a palm fat, to obtain the shortening composition.

38. A method of preparing the shortening composition of claim 20, wherein the method comprises chemical directed interesterification of a high stearic high oleic sunflower oil and a hard fat other than a palm fat to obtain the shortening composition.
